(19) United States
(12) Patent Application Publication
(10) Pub. No.: US 2017/0188543 A1
(43) Pub. Date: Jul. 6, 2017

(54) Pet Feeding and Watering Bowl

(71) Applicants: Mario Tota, Glendora, CA (US); Lilia Marin, Glendora, CA (US)

(72) Inventors: Mario Tota, Glendora, CA (US); Lilia Marin, Glendora, CA (US)

(21) Appl. No.: 15/351,396

(22) Filed: Nov. 14, 2016

Related U.S. Application Data
(60) Provisional application No. 62/255,275, filed on Nov. 13, 2015.

(51) Int. Cl. A01K 5/01; A01K 7/00

(52) U.S. Cl. CPC A01K 5/0142; A01K 7/00

(57) ABSTRACT

A pet feeding and watering bowl for protecting pet food from insects with water is provided. The pet feeding and watering bowl comprises an inner food bowl having a bottom wall surrounded by an outer wall with the inner food bowl capable of holding a predetermined amount of food. An outer water bowl is provided having a bottom wall surrounded by an outer wall with the outer water bowl completely surrounding the inner food bowl and the outer water bowl capable of holding a predetermined amount of water. The outer water bowl creates a moat around the inner food bowl using the water as a protective barrier to protect the pet food from insects.

### CLAIM OF PRIORITY

This patent application claims priority under 35 USC 119 (e) (1) from U.S. Provisional Patent Application Ser. No. 62/255,275 filed Nov. 13, 2015, of common inventorship herewith entitled, “Two in One Pet Bowl,” which is incorporated herein by reference as though the same were set forth in its entirety.

### FIELD OF THE INVENTION

The present invention pertains to the field of pet feeders, and more specifically to the field of food bowls configured to deter ants and insects.

### BACKGROUND OF THE INVENTION

In today's fast paced society, it is often a challenge to balance the demands of daily life. These daily demands sometimes make it difficult to provide an acceptable level of care for one's pet. Specifically, the task of feeding one's pet when at work or away from home presents many problems. Many pet owners are familiar with the fact that a pet's food attracts ants and other crawling insects. This problem is compounded when it is necessary to leave a feeding dish outdoors. When brought back inside, pet food attracts ants into a household, resulting in an insect problem within the home. Especially during warm weather, food left in an open container may become infested with ants within a matter of hours and consumption is difficult and unhealthy for a pet. Quite often, pets choose to go hungry and ignore the infested food bowl altogether. As a result, the owner discards and replaces entire bowls of food which is very wasteful and costly over time.

The prior art has put forth several designs for food bowls configured to deter ants and insects. Among these are:

US Patent Publication 2009/0229528 to James Carl McMurtry describes a pet food dish formed to protect the contents of the dish from ants. The illustrated dish has an upwardly open central portion for holding a quantity of pet food and allowing the pet access to the food. In one embodiment, the dish has a peripheral portion that is connected to and extends completely around the central food holding portion. The peripheral portion forms a seal with the central portion and defines an upwardly open, liquid holding trough that extends completely around the periphery of the dish. When the trough is filled with water or other liquid, it provides a moat or liquid barrier that prevents ants reaching the food in the dish. The trough is manufactured as part of the dish or provided as an add on attachment member to be removably assembled by the user with a standard dish. In another embodiment, a two member dish device comprises a separate dish member, a separate moat providing base member, and inter engaging means on said members to limit relative movement between them.

U.S. Pat. No. 6,520,114 to Ki Ho Chun describes a pet food dish having three separate compartments, including a central compartment for holding food, an inner surround compartment and an outer surrounding compartment. The inner surrounding compartment, which surrounds the central compartment, catches food which a pet may inadvertently remove from the central compartment and promptly drop. The outer surrounding compartment, which surrounds the inner surrounding compartment, holds water to deter pests from getting to the pet food. The three compartments are separated by upstanding walls sufficiently high to minimize the accidental exchange of material between compartments by passage over the top of the separating compartment walls.

U.S. Pat. No. 5,117,778 to Alvin H. Imamura describes an improved moated combination food and water animal feeding dish with nested offset triangular receptacles for improved resistance to tip over by maximizing the overall combined weight distribution characteristics of the food, water and dish combination. The feeding dish includes a pair of nested offset triangular receptacles, a floor, a first triangularly shaped dish secured to the floor. The first triangularly shaped dish has vertically arranged walls peripherally surrounding and disposed below the rim of a generally triangularly shaped second dish. The second dish is shaped similar to the first dish but is substantially larger than the first dish and disposed so that it surrounds the first dish, whereby the apexes of the first dish are placed in close proximity to the midpoint between each of the pairs of apexes of the second dish.

None of these prior art references describe the present invention.

### SUMMARY OF THE INVENTION

It is an object of the present invention to provide a pet feeding and watering bowl particularly configured to protect a pets food from ants and other insects by using water as a barrier.

The present invention is a pet feeding and watering bowl for protecting pet food from insects with water. The pet feeding and watering bowl comprises an inner food bowl having a bottom wall surrounded by an outer wall with the inner food bowl capable of holding a predetermined amount of food. An outer water bowl is provided having a bottom wall surrounded by an outer wall with the outer water bowl completely surrounding the inner food bowl and the outer water bowl capable of holding a predetermined amount of water. The outer water bowl creates a moat around the inner food bowl using the water as a protective barrier to protect the pet food from insects.

In addition, the present invention includes a method for protecting pet food from insects with water. The method comprises providing an inner food bowl having a bottom wall surrounded by an outer wall, loading the inner food bowl with a predetermined amount of food, providing an outer water bowl having a bottom wall surrounded by an outer wall, completely surrounding the inner food bowl with the outer water bowl, loading the outer water bowl with a predetermined amount of water, creating a moat around the inner food bowl, and using the water as a protective barrier to protect the pet food from insects.

The present invention further includes a pet feeding and watering bowl for protecting pet food from insects with water. The pet feeding and watering bowl comprises a centrally positioned inner food bowl having a bottom wail surrounded by an outer wall with the inner food bowl capable of holding a predetermined amount of food. An outer waterbowl is provided having a bottom wall surrounded by an outer wall with the outer water bowl completely surrounding the inner food bowl, the outer wall of the outer water bowl having an upwardly curving lip at a top of the outer wall of the outer water bowl, and the outer water bowl capable of holding a predetermined amount of water. The outer water bowl creates a moat around the inner food bowl using the water as a protective barrier to protect the pet food from insects.

### BRIEF DESCRIPTION OF THE DRAWINGS

FIG. 1 is a top down view of the present invention in a round shape, manufactured in a dark colored plastic material, and showing an inner area for food and an outer area for water.

FIG. 2 is a top down view of the present invention in a round shape, manufactured in a stainless steel material, and showing an inner area for food and an outer area for water.

FIG. 3 is a top down view of the present invention in a square shape, manufactured in a dark colored plastic material, and showing an inner area for food and an outer area for water.

FIG. 4 is a top down view of the present invention in a square shape, manufactured in a stainless steel material, and showing an inner area for food and an outer area for water.

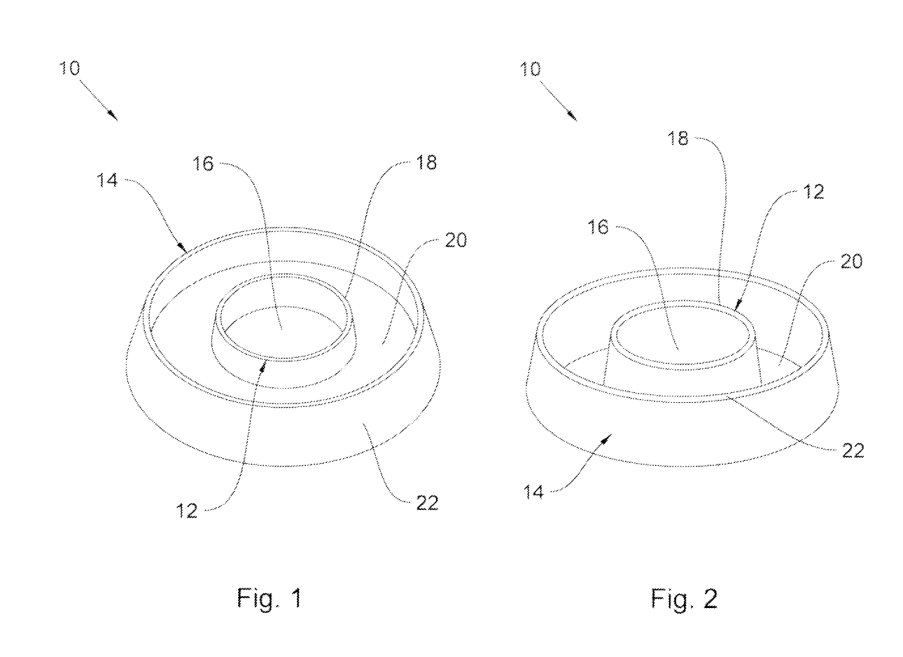

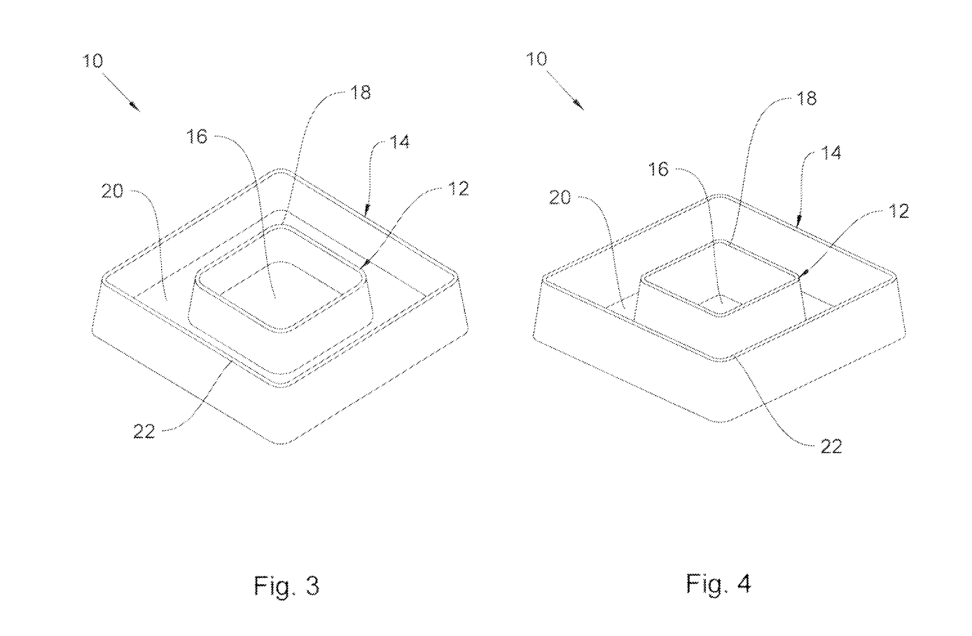

### DETAILED DESCRIPTION OF THE INVENTION

The present invention, hereinafter referred to as a Pet Feeding and Watering Bowl, indicated generally at 10, is a pet feeding and watering bowl particularly configured to protect a pet's food from ants and other insects by using water as a barrier. The Pet Feeding and Watering Bowl 10 utilizes water in a moat like effect, providing the food with a protective barrier against ants and other creepy crawlers.

The Pet Feeding and Watering Bowl 10 of the present invention comprises a centrally positioned inner food bowl 12 or receptacle for holding pet food which resides on top of or within an outer water bowl 14 or receptacle for holding water. The inner food bowl 12 has a bottom wall 16 surrounded by an outer wall 18 which divides the inner food bowl 12 from the outer water bowl 14. The outer water bowl 14 has a bottom wall 20 surrounded by an outer wall 22 which forms the perimeter of the Pet Feeding and Watering Bowl 10. Basically, the water-filled outer water bowl 14 creates a “moat” around the food-filled inner food bowl 12.

In a preferred embodiment of the Pet Feeding and Watering Bowl 10 of the present invention the outer wall 18 of the inner food bowl 12 has an upwardly curving lip at a top of the outer wall 18 of the inner food bowl 12 assisting in maintaining food within the inner food bowl 12. Also, in a preferred embodiment, the outer wall 22 of the outer water bowl 14 has an upwardly curving lip at a top of the outer wall 22 of the outer water bowl 14 assisting in maintaining water within the outer water bowl 14.

In an embodiment of the Pet Feeding and Watering Bowl 10 of the present invention, the outer wall 18 of the inner food bowl 12 has a height equal to a height of the outer wall 22 of the outer water bowl 14. In another embodiment, the outer wall 18 of the inner food bowl 12 has a height greater than a height of the outer wall 22 of the outer water bowl 14. In still another embodiment, the outer wall 18 of the inner food bowl 12 has a height less than a height of the outer wall 20 of the outer water bowl 14.

In an embodiment of the Pet Feeding and Watering Bowl 10 of the present invention, the bottom all 16 of the inner food bowl 12 is positioned at a level the same height as a level of the bottom wall 20 of the outer water bowl 14. In another embodiment, the bottom wall 16 of the inner food bowl 12 is positioned at a level above a level of the bottom wall 20 of the outer water bowl 14. In still another embodiment, the bottom wall 16 of the inner food bowl 12 is positioned at a level below a level of the bottom wall 20 of the outer water bowl 14.

The Pet Feeding and Watering Bowl 10 of the present invention is preferably constructed of a durable molded plastic or stainless steel material although constructing the Pet Feeding and Watering Bowl 10 from a different material is within the scope of the present invention. In addition, the Pet Feeding and Watering Bowl 10 is preferably constructed in a circular shape or a rectangular shape although constructing the Pet Feeding and Watering Bowl 10 in a different shape is within the scope of the present invention.

Total dimensions of a standard sized, rectangular shaped Pet Feeding and Watering Bowl 10 of the present invention is preferably approximately two (2″) inches in height, six (6″) inches in length, and four (4″) inches in width. Total dimensions of a circular shaped Pet Feeding and Watering Bowl 10 is preferably approximately two (2″) inches in height and five (5″) inches in diameter.

In the rectangular shaped Pet Feeding and Watering Bowl 10 of the present invention, the outer water bowl surrounds the perimeter of the inner food bowl 12 which measures approximately two (2″) inches in height,four (4″) inches in length, and two (2″) inches in width. The outer water bowl 14 creating the rectangular shaped moat section, between the outer wall 18 of the inner food bowl 12 and the outer wail 22 of the outer water bowl 14, surrounds the inner food bowl 12 and measures approximately two (2″) inches in width.

In the circular shaped Pet Feeding and Watering Bowl 10 of the present invention, the outer water bowl 14 surrounds the perimeter of the inner food bowl 12 which measures approximately two (2″) inches in height and three (3″) inches in diameter. As stated above, the inner food bowl 12 preferably has an upwardly and inwardly curving lip that lends surrounding walls with a depth that matches the height of the present invention. The outer water bowl 14 in the circular shaped moat section, created between the outer wall 18 of the inner food bowl 12 and the outer wall 22 of the outer water bowl 14, surrounds the inner food bowl 12 and measures approximately two (2″) inches in width.

The aforementioned configuration of outer walls 18, 22 with upwardly and inwardly curving lips keeps water placed inside the outer water bowl 14 from spilling over on the floor. The Pet Feeding and Watering Bowl 10 is preferably manufactured in varying sizes, designated as small, medium or standard, and large to accommodate the size of the pet. In addition, the Pet Feeding and Watering Bowl 10 is manufactured in a wide variety of colors and whimsical patterns of style.

Using the Pet Feeding and Watering Bowl 10 of the present invention is very simple and straightforward. The pet owner fills the inner food bowl 12 with their pets preferred brand of food. The pet owner fills the outer water bowl 14 with water. In this manner, the pet owner has created a moat effect, as the pet food is surrounded by a barrier of water. Upon encountering the water, ants, and other insects abandon pursuit of the food and avoid the water and food in the Pet Feeding and Watering Bowl 10 altogether. As a result the pet has fresh food and water available in one convenient feed and water bowl.

The Pet Feeding and Watering Bowl 10 of the present invention effectively prevents infestation of pet food by ants and other crawling insects. Since ants cannot travel through water, the water moat that surrounds the pet's food functions as an impenetrable barrier. The natural water barrier system prevents an animal from becoming sick from consuming infested food. Using the Pet Feeding and Watering Bowl 10 effectively functions to reduce the occurrences of one's home being infested with insects. Constructed of durable and high quality material, the Pet Feeding and Watering Bowl 10 will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A pet feeding and watering bowl for protecting pet food from insects with water, the pet feeding and watering bowl comprising:
an inner food bowl having a bottom wall surrounded by an outer wall, the inner food bowl capable of holding a predetermined amount of food; and
an outer water bowl having a bottom wall surrounded by an outer wall, the outer water bowl completely surrounding the inner food bowl, the outer water bowl capable of holding a predetermined amount of water;
wherein the outer water jowl creates a moat around the inner food bowl using the water as a protective barrier to protect the pet food from insects.

2. The pet feeding and watering bowl of claim 1 wherein the inner food bowl is centrally positioned within the outer water bowl.

3. The pet feeding and watering bowl of claim 1 wherein the outer wall of the inner food bowl has an upwardly curving lip at a top of the outer wall of the inner food bowl assisting in maintaining food within the inner food bowl.

4. The pet feeding and watering bowl of claim 1 wherein the outer wall of the outer water bowl has an upwardly curving lip at a top of the outer wall of the outer water bowl assisting in maintaining water within the outer water bowl.

5. The pet feeding and watering bowl of claim 1 wherein the outer wall of the inner food bowl has a height equal to a height of the outer wall of the outer water bowl.

6. The pet feeding and watering bowl of claim 1 wherein the outer wall of the inner food bowl has a height greater than a height of the outer wall of the outer water bowl.

7. The pet feeding and watering bowl of claim 1 wherein the outer wall of the inner food bowl has a height less than a height of the outer wall of the outer water bowl.

8. The pet feeding and watering bowl of claim 1 wherein the bottom wall of the inner food bowl is positioned at a level the same height as a level of the bottom wall of the outer wall of the outer water bowl.

9. The pet feeding and watering bowl of claim 1 wherein the bottom wall of the inner food bowl is positioned at a level above a level of the bottom wall of the outer water bowl.

10. The pet feeding and watering bowl of claim 1 wherein the bottom wall of the inner food bowl is positioned at a level below a level of the bottom wall of the outer water bowl.

11. The pet feeding and watering bowl of claim 1 wherein the pet feeding and watering bowl is a circular shape or a rectangular shape.

12. A method for protecting pet food from insects with water, the method comprising:
providing an inner food bowl having a bottom wall surrounded by an outer wall;
loading the inner food bowl with a predetermined amount of food;
providing an outer water bowl having a bottom wall surrounded by an outer wall;
completely surrounding the inner food bowl with the outer water bowl;
loading the outer water bowl with a predetermined amount of water;
creating a moat around the inner food bowl; and
using the water as a protective barrier to protect the pet food from insects.

13. A pet feeding and watering bowl for protecting pet food from insects with water, the pet feeding and watering bowl comprising:
a centrally positioned inner food bowl having a bottom wall surrounded by an outer wall, the inner food bowl capable of holding a predetermined amount of food; and
an outer water bowl having a bottom wall surrounded by an outer wall, the outer water bowl completely surrounding the inner food bowl, the outer wall of the outer water bowl having an upwardly curving lip at a top of the outer wall of the outer water bowl, the outer water bowl capable of holding a predetermined amount of water;
wherein the outer water bowl creates a moat around the inner food bowl using the water as a protective barrier to protect the pet food from insects.

14. The pet feeding and watering bowl of claim 13 wherein the outer wall of the inner food bowl has an upwardly curving lip at a top of the outer wall of the inner food bowl assisting in maintaining food within the inner food bowl.

15. The pet feeding and watering bowl of claim 13 wherein the outer wall of the inner food bowl has a height equal to a height of the outer wall of the outer water bowl,

16. The pet feeding and watering bowl of claim 13 wherein the outer wall of the inner food bowl has a height greater than a height of the outer wall of the outer water bowl.

17. The pet feeding and watering bowl of claim 13 wherein the outer wall of the inner food bowl has a height less than a height of the outer wall of the outer water bowl.

18. The pet feeding and watering bowl of claim 13 wherein the bottom wail of the inner food bowl is positioned at a level the same height as a level of the bottom all of the outer wall of the outer water bowl.

19. The pet feeding and watering bowl of claim 13 wherein the bottom wall of the inner food bowl is positioned at a level above a level of the bottom wall of the outer water bowl.

20. The pet feeding and watering bowl of claim 13 wherein the bottom wall of the inner food bowl is positioned at a level below a level of the bottom wall of the outer water bowl.
